(19) United States
(12) Patent Application Publication
(10) Pub. No.: US 2014/0249998 A1
(43) Pub. Date: Sep. 4, 2014

(54) ELECTRONIC RECEIPT SYSTEM, ELECTRONIC RECEIPT MANAGING SERVER, INFORMATION PROCESSING DEVICE, AND INFORMATION PROCESSING METHOD

(71) Applicant: TOSHIBA TEC KABUSHIKI KAISHA, Tokyo (JP)

(72) Inventors: Tsuyoshi GOTANDA, Tokyo (JP); Taro ANDO, Shizuoka (JP); Akiko SUSAKI, Tokyo (JP); Yumiko OKUMA, Tokyo (JP); Maki SATO, Kanagawa (JP); Takuro MASUDA, Tokyo (JP)

(73) Assignee: TOSHIBA TEC KABUSHIKI KAISHA, Tokyo (JP)

(21) Appl. No.: 14/194,563

(22) Filed: Feb. 28, 2014

(30) Foreign Application Priority Data
Mar. 1, 2013 (JP) 2013-041247
Aug. 2, 2013 (JP) 2013-161176

(51) Int. Cl. G06Q 20/08

(52) U.S. Cl. CPC G06Q 20/08
USPC 705/39

(57) ABSTRACT

An electronic receipt managing server includes a reception unit configured to receive electronic receipt information relating to a sale of a merchandise at a store to a consumer, an electronic receipt management unit configured to manage the electronic receipt information, an additional information management unit configured to manage additional information, for example, warranty information, of the merchandise with the electronic receipt information, an electronic receipt transmission unit configured to transmit the electronic receipt information to an information processing device associated with a code of the consumer, and an additional information transmission unit configured to transmit the additional information to the information processing device.

### CROSS-REFERENCE TO RELATED APPLICATION

This application is based upon and claims the benefit of priority from Japanese Patent Application No. 2013-041247, filed Mar. 1, 2013 and Japanese Patent Application No. 2013-161176, filed Aug. 2, 2013; the entire contents of both applications are incorporated herein by reference.

### FIELD

Embodiments described herein relate generally to an electronic receipt system, an electronic receipt managing server, and an information processing device and an information processing method.

### BACKGROUND

In an electronic receipt system of the related art, a receipt given to a consumer who is a shopper at a store, at the time of payment is electronically delivered to a mobile terminal of the consumer.

It is possible to reduce consumption of receipt paper by providing the receipt in electronic form. Thus, it is useful for a store introducing the system.

In addition, it is also known that a merchandise promotion or promotional advertising may be performed by electronically attaching a coupon relating to the purchased merchandise to the electronic receipt.

However, for a merchandise such as electrical appliances, for example, a warranty for a purchased merchandise which is valid for a certain period of time (for example, for one year) is handed to a consumer when purchasing the merchandise. In the warranty, information which certifies the merchandise purchase by the consumer, such as the model of merchandise under warranty, the warranty period, and a date of purchase, is printed or filled in. Electronic processing of a warranty has not been implemented yet even though the electronic receipt system has been introduced.

### DESCRIPTION OF THE DRAWINGS

FIG. 1 is a configuration diagram which illustrates the overall configuration of an electronic receipt system according to an embodiment.

FIG. 2 is a block diagram which illustrates a configuration of a mobile terminal.

FIG. 3 is a block diagram which illustrates a configuration of a POS terminal.

FIG. 4 is a block diagram which illustrates a configuration of an electronic receipt server.

FIG. 5 is a block diagram which illustrates a configuration of an electronic receipt managing server.

FIG. 6 is a functional block diagram according to electronic receipt processing performed in the POS terminal.

FIG. 7 is a flowchart which illustrates a flow of processes of the electronic receipt and issuing of a warranty performed in the POS terminal.

FIG. 8 is a functional block diagram of electronic receipt managing processing, and warranty processing performed in the electronic receipt server.

FIG. 9 is a flowchart which illustrates a flow of the electronic receipt managing processing and the warranty processing performed in the electronic receipt server.

FIG. 10 is a functional block diagram of the electronic receipt managing processing, merchandise information transmission processing, and the warranty processing performed in the electronic receipt managing server.

FIG. 11 is a flowchart which illustrates a flow of the electronic receipt managing processing, the merchandise information transmission processing, and the warranty processing performed in the electronic receipt managing server.

FIG. 12 is a functional block diagram of electronic receipt reception processing, electronic receipt reading processing, and a warranty information display processing performed in the mobile terminal.

FIG. 13 is a flowchart which illustrates a flow of the electronic receipt reception processing, the electronic receipt reading processing, and the warranty information display processing performed in the mobile terminal.

FIG. 14 is a front view which illustrates a display example in the mobile terminal.

FIG. 15 is a front view which illustrates a display example in the mobile terminal.

FIG. 16 is a front view which illustrates a display example in the mobile terminal.

FIG. 17 is a front view which illustrates a display example of the warranty in the mobile terminal.

FIG. 18 is a flowchart which illustrates a flow of the electronic receipt reception processing, and the electronic receipt reading processing performed in the mobile terminal.

### DETAILED DESCRIPTION

Embodiments provide an electronic receipt system which performs electronic processing with respect to additional information relating to a purchased merchandise such as a warranty, for example, an electronic receipt managing server, an information processing device, and an information processing method.

In general, according to one embodiment, an electronic receipt managing server includes a reception unit configured to receive electronic receipt information relating to a sale of a merchandise at a store to a consumer, an electronic receipt management unit configured to manage the electronic receipt information, an additional information management unit configured to manage additional information, for example, warranty information, of the merchandise with the electronic receipt information, an electronic receipt transmission unit configured to transmit the electronic receipt information to an information processing device associated with a code of the consumer, and an additional information transmission unit configured to transmit the additional information to the information processing device.

One embodiment will be described with reference to the drawings.

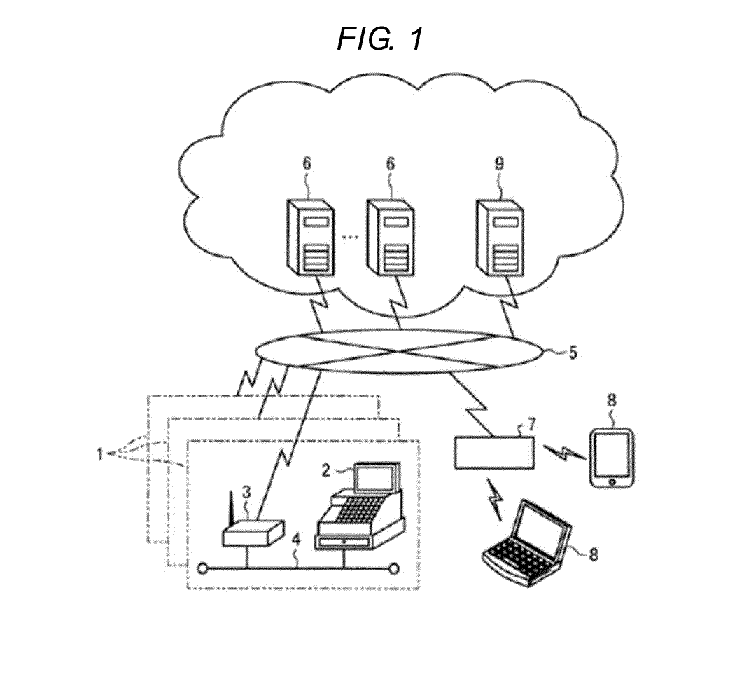

FIG. 1 is a configuration diagram which illustrates the overall configuration of an electronic receipt system according to the embodiment. As illustrated in FIG. 1, a store 1 is provided with a Point of Sales (POS) terminal 2 which is a merchandise sales data processing device (only one terminal is displayed in FIG. 1, however, a plurality of terminals may be used) which executes merchandise sales data processing, and a router 3. The store 1 may be a store or a chain store (hereinafter, referred to as a store) such as a convenience store, a supermarket, a food store, a drug store, an apparel store, a home electric appliance store, a department store, a household goods store, and a restaurant. The POS terminal 2 and the router 3 are connected through a Local Area Network (LAN) 4 in the store. The router 3 is an appliance for connecting the LAN 4 in the store and a network 5 being, e.g., the Internet, or a virtual Private Network (VPN). In addition, though it is not particularly illustrated, the store 1 may be provided with a store server which integrates the POS terminal 2.

An electronic receipt server 6 is connected to the network 5. A plurality of electronic receipt servers 6 are provided, one for each company which is a seller of a merchandise or a service and manages a store, and each functions as a receipt managing server for a company operating a store and each stores and manages electronic receipt information for the company using a code that uniquely identifies the company. In addition, the electronic receipt server 6 stores warranty information (additional information) relating to each merchandise. In addition, the electronic receipt server 6 may be servers of headquarters of a POS system having functions of sales management, sales analysis, inventory control, and the like, of each company operating a store.

In addition, a mobile terminal 8 is connected to the network 5 through a base station 7 which performs a wireless communication according to a standard such as Wireless Fidelity (Wi-Fi). The mobile terminal 8 is an information processing device such as a smart phone, a mobile phone, a Personal Digital Assistant (PDA), a tablet computer, for example, in which a Web browser is loaded. In addition, an information processing device of a personal computer, or the like, such as a notebook personal computer may be applied, instead of the mobile terminal 8.

In addition, an electronic receipt managing server 9 is connected to the network 5. Electronic receipt managing server 9 stores and manages electronic receipt information of various companies operating stores in a collective manner. A consumer who is registered as a member, so as to receive electronic receipts may obtain electronic receipt information from the electronic receipt managing server 9 using the mobile terminal 8 through the network 5. The electronic receipt managing server 9 is managed by a trusted third party other than a company which manages the electronic receipt information in the electronic receipt server 6. In addition, the electronic receipt server 6 may be also managed by the trusted third party, or the like. In addition, a single server may be used by causing the electronic receipt managing server 9 to have the function of the electronic receipt server 6. In addition, a function in which electronic receipt information of each company identifying a company operating a store is collectively managed using a plurality of company codes, may be provided as a service (application) in a form of a Software as a Service (SaaS) which is a type of cloud computing, for example.

In addition, registration of a consumer as a member for receiving an electronic receipt service is performed as follows, for example. A consumer sends an empty e-mail to a member managing server through the network 5 from the mobile terminal 8. The member managing server transmits a Uniform Resource Locator (URL) identifying a page where the membership registration can be accomplished to the e-mail address of the empty e-mail. The consumer accesses the URL identifying the page for the membership registration from the mobile terminal 8, causes the mobile terminal 8 to display an input screen H, and inputs requirements for the membership registration. An input confirmation screen is displayed on the mobile terminal 8 in which the input of the requirements by the consumer is completed. In addition, after the input confirmation by the consumer, a membership registration with respect to the member is executed. Thereafter, the member managing server delivers a membership code and a membership registration completion e-mail including a password to the mobile terminal 8. In this manner, the membership registration is completed.

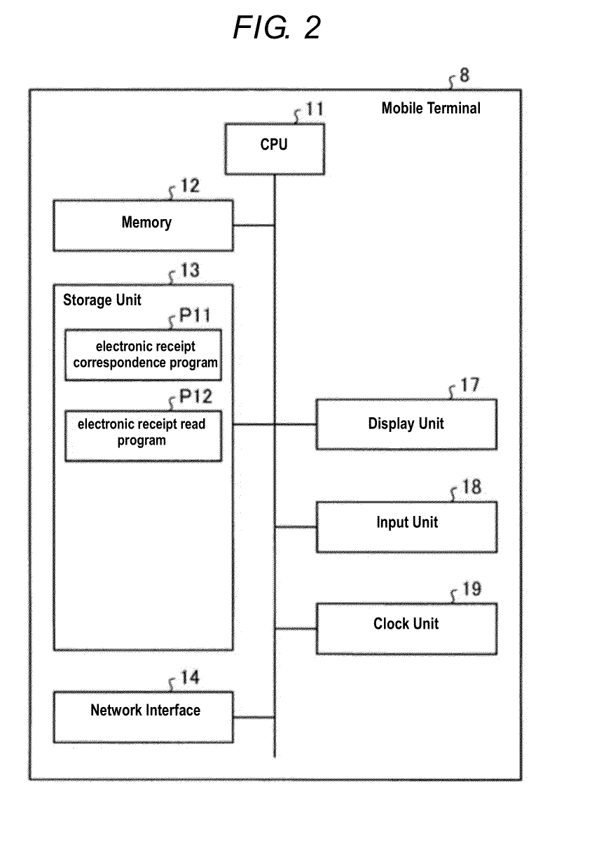

In the electronic receipt system with the configuration of FIG. 1, electronic receipt information including payment information which is generated when merchandise sales data processing is performed in the POS terminal 2 of the store 1, is transmitted to the electronic receipt managing server 9 through the network 5, and the electronic receipt server 6, and the electronic receipt information is transmitted to the mobile terminal 8 of a member from the electronic receipt managing server 9. The member may confirm the contents by causing the electronic receipt information to be displayed on a display unit of the mobile terminal 8. In addition, the electronic receipt managing server 9 makes the electronic receipt information available for access using a Web browser. The mobile terminal 8 on which the Web browser is loaded may read the electronic receipt information using the Web browser by designating a URL and downloading the information to the mobile terminal 8. In addition, the information may be read by installing application software for reading the electronic receipt information using the mobile terminal 8. The mobile terminal 8 stores a membership code, and a password which are obtained as described above by a consumer in a storage unit 13 (refer to FIG. 2), or the like. A method of outputting the membership code which is stored in this manner includes a display using a barcode, a display using a two-dimensional code, and a transmission using an information communication by a Near Field Communication (NFC) which is a near field wireless communication, or the like.

Hereinafter, a configuration of each unit which makes up an electronic receipt system according to the embodiment, will be described.

First, a configuration of the mobile terminal 8 as an information processing device will be described using a block diagram in FIG. 2. As illustrated in FIG. 2, the mobile terminal 8 is configured of a Central Processing Unit (CPU) 11 functioning as a control unit, a memory 12 for temporarily storing data, a storage unit 13 which may perform reading and writing of data according to a command from the CPU 11, and in which a program, data, or the like, is stored, a network interface 14 which is connected to various public networks including the network 5, a display unit 17 which may display various pieces of information, an input unit 18 which operates the mobile terminal 8, a clock unit 19 which tracks time, or the like. The input unit 18 is a touch panel which is laminated on the display unit 17, or keys which are provided on a housing.

In the storage unit 13, an electronic receipt correspondence program P11 for receiving electronic receipt information which is generated after a settlement due to the merchandise sales data processing from the electronic receipt managing server 9, and an electronic receipt read program P12 for reading the received electronic receipt information are pre-installed, in addition to the Web browser for accessing and displaying various pieces of information (contents).

In addition, the electronic receipt correspondence program P11 and the electronic receipt read program P12 which are executed in the mobile terminal 8 are provided by being recorded in a computer-readable recording medium such as a CD-ROM, a flexible disk (FD), a CD-R, and a Digital Versatile Disc (DVD) as a file in a form which may be installed, or in a form which may be executed.

In addition, the electronic receipt correspondence program P11 and the electronic receipt read program P12 which are executed in the mobile terminal 8 may be configured so as to be provided by the programs being stored in a computer which is connected to a network such as the Internet, and being downloaded through the network. In addition, the electronic receipt correspondence program P11 and the electronic receipt read program P12 which are executed in the mobile terminal 8 may be configured so as to be provided or distributed through a network such as the Internet.

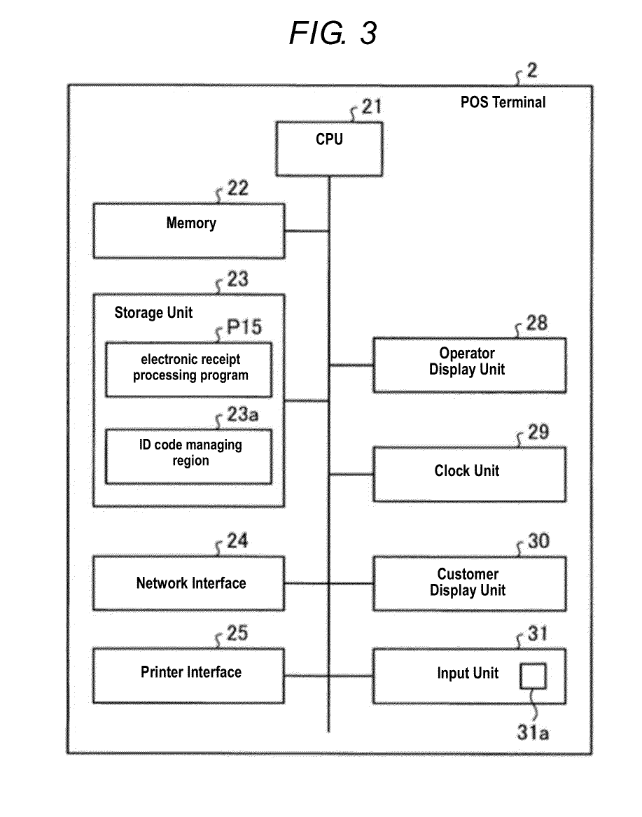

Subsequently, a configuration of the POS terminal 2 as a merchandise sales data processing device will be described using a block diagram in FIG. 3. As illustrated in FIG. 3, the POS terminal 2 is configured of a CPU 21 functioning as a control unit, a memory 22 which temporarily stores data, a storage unit 23 which may perform reading and writing according to a command from the CPU 21, and in which a program, data, or the like, is stored, a network interface 24 which is connected to a LAN 4 in a store, a printer interface 25 to which a printer is connected, a display unit for an operator 28 which displays various pieces of information with respect to an operator, a clock unit 29 which tracks time, a display unit for a customer 30 which displays various pieces of information with respect to a customer, an input unit 31 which operates the POS terminal 2, and the like. The input unit 31 is provided with a settlement key 31a which executes settlement processing with respect to input merchandise information.

In the storage unit 23, in addition to a POS number of the POS terminal 2, an identification code managing region 23a is secured as a region for storing a company code (identification code of company operating a store), codes of a type of business, a store code which denotes the store 1 in which the POS terminal 2 is provided, or the like. Here, the codes of the type of business are codes which classify a type of a business of the store 1 (classification code), such as a convenience store, a supermarket, a department store, a drug store, a restaurant, or the like. In addition, such a type of business may be arbitrarily changed depending on a user's preference. In addition, the company code (identification code of company operating a store), and the codes of the type of business, may be registered in the electronic receipt server 6.

In addition, in the storage unit 23, an electronic receipt processing program P15 which processes electronic receipt information instead of printing the receipt which is issued when performing merchandise sales data processing, is pre-installed, in addition to software for executing various POS operations including the merchandise sales data processing.

In addition, the electronic receipt processing program P15 which is executed in the POS terminal 2, is provided by being recorded in a computer-readable recording medium such as a CD-ROM, a flexible disk (FD), a CD-R, and a DVD as a file in a form which may be installed, or in a form which may be executed.

In addition, the electronic receipt processing program P15 which is executed in the POS terminal 2 may be configured so as to be provided by being stored in a computer which is connected to a network such as the Internet, and being downloaded through the network. In addition, the electronic receipt processing program P15 which is executed in the POS terminal 2 may be configured so as to be provided or distributed through a network such as the Internet.

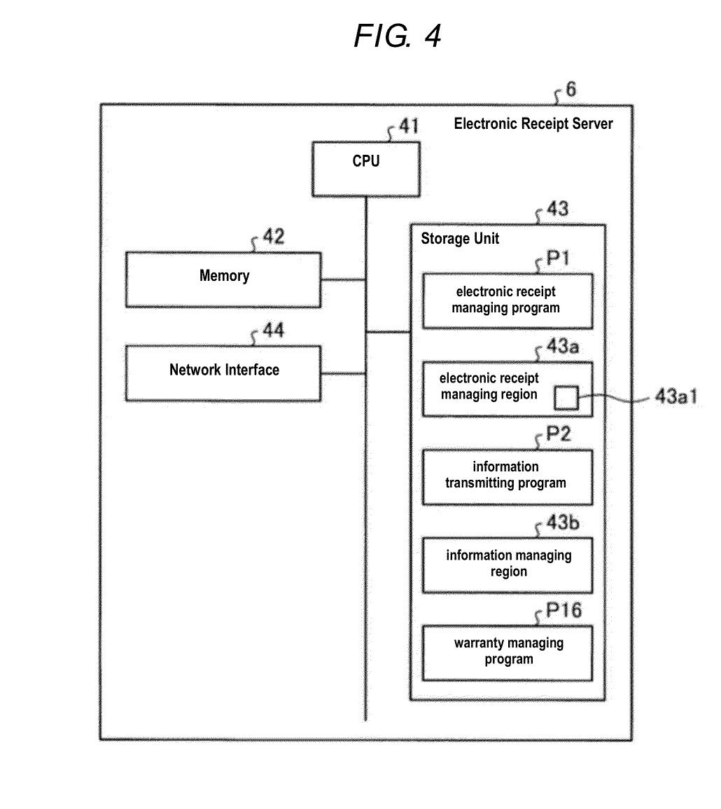

Subsequently, a configuration of the electronic receipt server 6 which functions as a receipt managing server for a company, and is provided for each company will be described using a block diagram in FIG. 4. The electronic receipt server 6 is configured with a CPU 41 functioning as a control unit, a memory 42 which temporarily stores data, a storage unit 43 which may perform reading and writing according to a command from the CPU 41, and in which a program, data, or the like, is stored, a network interface 44 which is connected to the network 5, and the like.

In the storage unit 43, an electronic receipt managing region 43a is secured as a region for storing electronic receipt information for each company operating a store. The electronic receipt information includes a company code (identification code of company operating the store 1), codes of a type of business, a store code, a membership code of a consumer, a POS number of the POS terminal 2, a receipt number, merchandise sales data, and the like.

In addition, a warranty managing region 43a1 (additional information storage unit) which stores warranty information of a merchandise which needs a warranty is secured in the electronic receipt managing region 43a. In the warranty managing region 43a1, merchandise information of a merchandise for which a warranty is issued, information on a warranty period, information on warranty terms, information on a contact address of the manufacturer, or the like, are stored for each merchandise under warranty.

In addition, in the storage unit 43, an electronic receipt managing program P1 for managing electronic receipt information which is received from the POS terminal 2 of each store 1 is pre-installed in the electronic receipt managing region 43a.

In addition, in the storage unit 43, an information transmitting program P2 which transmits the electronic receipt information, which is managed in the electronic receipt managing region 43a, to the electronic receipt managing server 9, and a warranty managing program P16, which searches the warranty managing region 43a1 based on the electronic receipt information that is received from the POS terminal 2, determines whether or not the warranty information is stored in the warranty managing region 43a1, and transmits the warranty information which is determined as being stored to the electronic receipt managing server 9, are pre-installed.

In addition, in the storage unit 43, an information managing region 43b which stores various pieces of advertising information which are associated with a desired merchandise, a member, a company, and a store is provided. Here, the advertising information is access information such as a URL which is linked to a homepage correlated with a campaign of a company, a URL which is linked to a homepage correlated with a commercial of a company, and a URL which is linked to a coupon of a company.

In addition, the electronic receipt managing program P1 and the information transmitting program P2 which are executed in the electronic receipt server 6 are provided by being recorded in a computer-readable recording medium such as a CD-ROM, a flexible disk (FD), a CD-R, and a DVD as a file in a form which may be installed, or in a form which may be executed.

In addition, the electronic receipt managing program P1 and the information transmitting program P2 which are executed in the electronic receipt server 6 may be configured so as to be provided by being stored in a computer which is connected to a network such as the Internet, and being downloaded through the network. In addition, the electronic receipt managing program P1 and the information transmitting program P2 which are executed in the electronic receipt server 6 may be configured so as to be provided or distributed through a network such as the Internet.

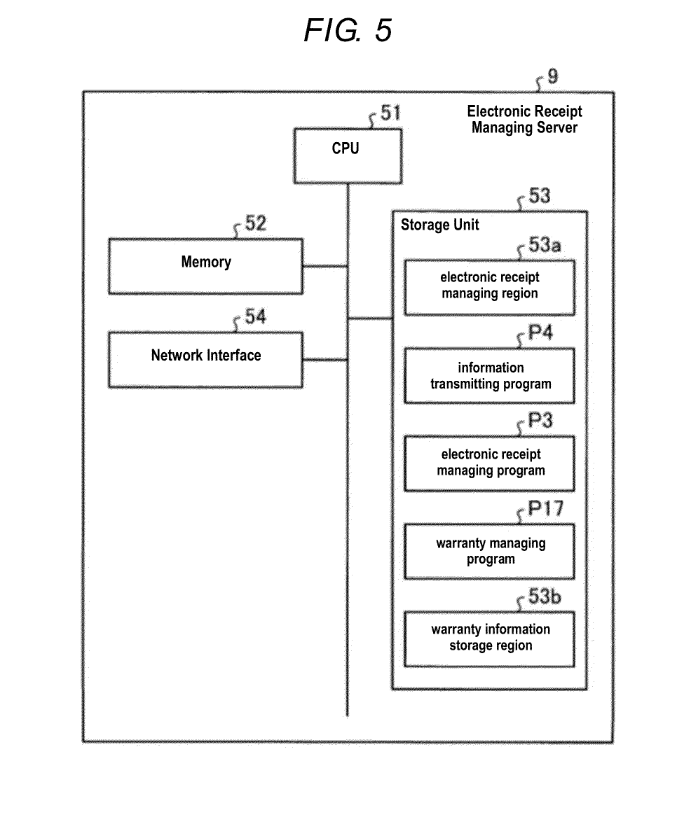

Subsequently, a configuration of the electronic receipt managing server 9 which functions as the receipt managing server for a customer will be described using a block diagram in FIG. 5. The electronic receipt managing server 9 is configured with a CPU 51 functioning as a control unit, a memory 52 which temporarily stores data, a storage unit 53 which may perform reading and writing according to a command from the CPU 51, and in which a program, data, or the like, is stored, a network interface 54 which is connected to the network 5, and the like.

In the storage unit 53, an electronic receipt managing region 53a in which electronic receipt information of various companies operating the stores 1 is collectively stored, is secured. More specifically, the electronic receipt managing region 53a manages the electronic receipt information and advertising information of various companies operating the stores 1 for each member. The electronic receipt information includes a membership code, a company code (identification code of company operating the store 1), a store code, a POS number of the POS terminal 2, a receipt number, merchandise sales data, advertising information, or the like.

In addition, in the storage unit 53, a warranty information storage region 53b (additional information storage unit) is secured. In the warranty information storage region 53b, warranty information (additional information) which is transmitted from the electronic receipt server 6 is stored in association with information about the corresponding merchandise under warranty. The warranty information for each merchandise under warranty includes merchandise information, information on a warranty period, information on warranty regulations, information on a contact address of the manufacturer, and the like. In addition, the date on which the warranty information is received from the electronic receipt server 6 is stored in the warranty information storage region 53b. Whether or not a merchandise is within the warranty period, which will be described later, is determined based on the received date and the information on the warranty period.

In addition, in the storage unit 53, an electronic receipt managing program P3 which manages the advertising information and the electronic receipt information which are received from the electronic receipt server 6 of various companies in the electronic receipt managing region 53a is pre-installed.

In addition, in the storage unit 53, an information transmitting program P4, which transmits electronic receipt information and advertising information of a particular merchandise to the mobile terminal 8, and a warranty managing program P17, which manages warranty information which is transmitted from the electronic receipt server 6, determines whether or not the warranty period has expired for the merchandise, and transmits the warranty information to the mobile terminal 8, are pre-installed.

In addition, the electronic receipt managing program P3 and the information transmitting program P4 which are executed in the electronic receipt managing server 9 are provided by being recorded in a computer-readable recording medium such as a CD-ROM, a flexible disk (FD), a CD-R, and a DVD as a file in a form which may be installed, or in a form which may be executed.

In addition, the electronic receipt managing program P3 and the information transmitting program P4, which are executed in the electronic receipt managing server 9, may be configured so that the programs are stored in a computer which is connected to a network such as the Internet, and are downloaded through the network. In addition, the electronic receipt managing program P3 and the information transmitting program P4, which are executed in the electronic receipt managing server 9, may be configured so as to be provided or distributed through a network such as the Internet.

Subsequently, operations of each unit which makes up the system according to the embodiment will be described.

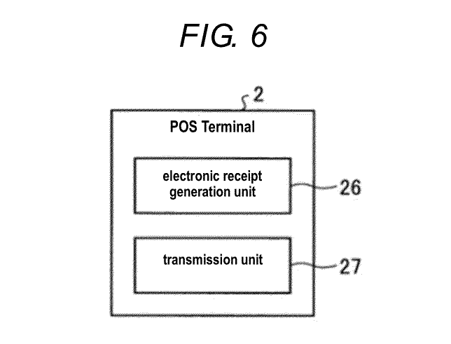

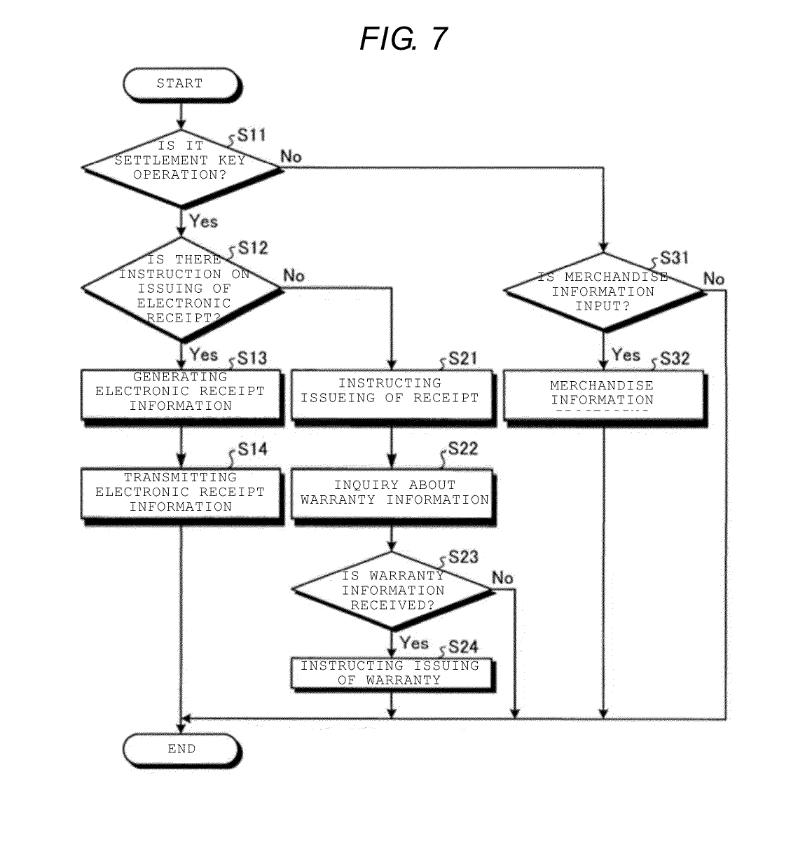

First, electronic receipt processing which is executed when the CPU 21 of the POS terminal 2 is operated according to the electronic receipt processing program P15 will be described while referring to a functional block diagram which is illustrated in FIG. 6, and a flowchart which is illustrated in FIG. 7.

As illustrated in FIG. 6, the electronic receipt processing program P15 which is executed in the POS terminal 2 has a modular configuration including an electronic receipt generation unit 26 which functions as the electronic receipt generation means, and a transmission unit 27 which functions as the transmission means. Each of the above-described units is loaded in the memory 22, and the electronic receipt generation unit 26, and the transmission unit 27 are generated in the memory 22 when the CPU 21 as actual hardware reads and executes the electronic receipt processing program P15 from the storage unit 23.

The electronic receipt generation unit 26 includes a company code identifying a company operating the store 1, and generates electronic receipt information which is electronically processed instead of a receipt which is printed, and issued when performing merchandise sales data processing by causing the information to be associated with a membership code of a consumer.

The transmission unit 27 transmits the electronic receipt information which is generated in the electronic receipt generation unit 26 to the electronic receipt server 6 which manages the information of each company according to a company code.

Subsequently, merchandise information processing and settlement processing in the POS terminal 2 will be described using the flowchart in FIG. 7. The merchandise information processing is processing in which a name of a merchandise, a price, or the like, is displayed, stored, or the like, by being read from a merchandise database based on merchandise information relating to an input merchandise to be purchased. The settlement processing is processing in which the total amount is calculated, received money is input, change is calculated, and the receipt is printed and issued based on input merchandise information. The settlement processing is executed by the CPU 21 when the settlement key 31a which is provided in the input unit 31 is operated.

The CPU 21 of the POS terminal 2 determines whether or not the settlement key 31a is operated (step S11). When it is determined that the key is operated (Yes in step S11), the CPU 21 determines whether or not issuing of an electronic receipt is instructed (step S12).

The following methods, for example, are taken into consideration in order for a member to express an instruction to issue the electronic receipt.

1. A salesperson operates a button for “issuing electronic receipt” which is provided in the input unit 31 (for example, keyboard) of the POS terminal 2.

2. A consumer who is a member displays a barcode including a code as a trigger on the display unit 17 of the mobile terminal 8, and a salesperson reads the input unit 31 (for example, barcode scanner) of the POS terminal 2.

3. A consumer who is a member operates the button for “issuing electronic receipt” which is displayed on the display unit for a customer 30 so as to be pressed.

4. A consumer who is a member displays a barcode including a code as a trigger on the display unit 17 of the mobile terminal 8, and the consumer who is the member reads the input unit 31 (for example, barcode scanner (it is preferable that the scanner be a different scanner from the scanner which is used in merchandise registration)) of the POS terminal 2.

5. A consumer who is a member presents a membership card in a rewards program of a company offering a point service, a membership code of the membership card of the company is read in the input unit 31 (for example, barcode scanner, magnetic card reader, NFC, or the like) of the POS terminal 2, and it is determined that there is an instruction on issuing of the electronic receipt when a membership code of the electronic receipt correlates with the read membership code.

When it is determined that issuing of the electronic receipt is instructed (Yes in step S12), the CPU 21 (electronic receipt generation unit 26) generates electronic receipt information based on merchandise information and settlement information (step S13). The CPU 21 extracts a company code (identification code of company operating the store 1), codes of a type of business, a store code, a membership code of a consumer, a POS number of the POS terminal 2, a receipt number, and the like, from a merchandise sales data managing region which is provided in the memory 22 in addition to the merchandise information, and generates an electronic receipt information based on the information. In addition, the CPU 21 (transmission unit 27) transmits the generated electronic receipt information to the electronic receipt server 6 with the information correlated with the membership code of the consumer (step S14).

In addition, when the CPU 21 determines that issuing of the electronic receipt is not instructed in step S12 (No in step S12), the CPU 21 generates receipt information based on the merchandise information and the settlement information, and instructs issuing of the receipt by transmitting the information to a printer interface 25 (step S21). A printer which is connected to the printer interface 25 prints the receipt information, and issues a receipt.

Subsequently, the CPU 21 makes an inquiry about warranty information (additional information) with respect to the electronic receipt server 6 (step S22). In addition, the CPU 21 determines whether or not the warranty information with respect to the inquiry is received from the electronic receipt server 6 (step S23). When it is determined that the information is received (Yes in step S23), the CPU 21 transmits the received warranty information to the printer interface 25, and instructs issuing of a warranty (step S24). The printer which is connected to the printer interface 25 prints the warranty information (additional information), and issues a warranty. In addition, when it is determined that the CPU 21 does not receive the warranty information since there is no warranty information as a result of the inquiry on the warranty information (No in step S23), the CPU 21 ends the process.

In addition, when it is determined that the settlement key 31a is not operated in step S11 (No in step S11), the CPU 21 determines whether or not the merchandise information is input (step S31). When it is determined that the merchandise information is input (Yes in step S31), the CPU 21 executes merchandise information processing (step S32). When it is determined that the merchandise information is not input (No in step S31), the CPU 21 ends the process.

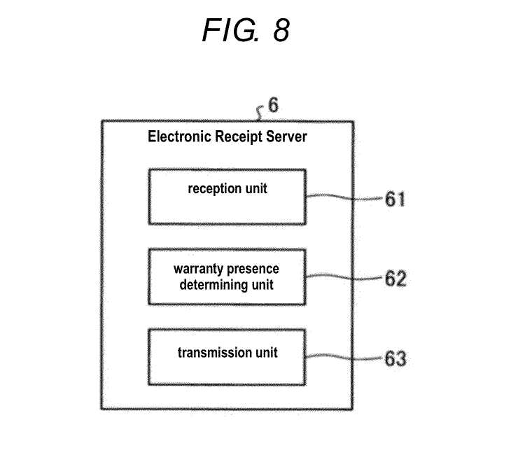

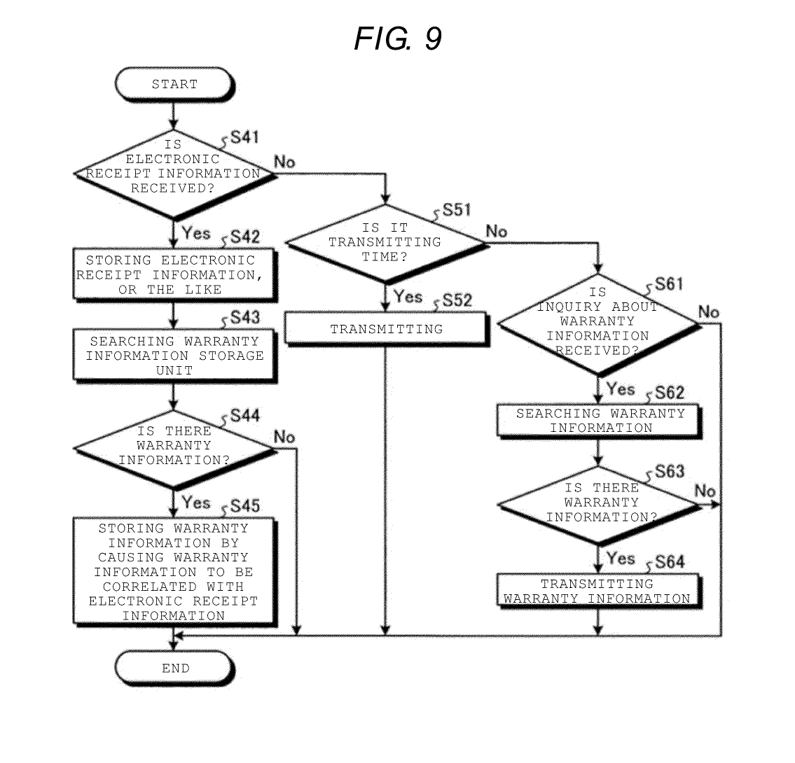

Subsequently, a flow of electronic receipt managing processing, which is executed when a CPU 41 of the electronic receipt server 6 is operated according to the electronic receipt managing program P1, and a flow of information transmission processing, which is executed when the CPU of the electronic receipt server is operated according to the information transmitting program P2, will be described with reference to a functional block diagram illustrated in FIG. 8, and a flowchart illustrated in FIG. 9.

As illustrated in FIG. 8, the electronic receipt managing program P1 which is executed in the electronic receipt server 6 includes a reception unit 61 which functions as the reception means. In addition, a warranty managing program P16 which is executed in the electronic receipt server 6 includes a warranty presence determining unit 62 which functions as the additional information presence determination means, and a transmission unit 63 which functions as the transmission means. Each of the above-described units is loaded in a memory 42, and the reception unit 61, the warranty presence determining unit 62, and the transmission unit 63 are generated in the memory 42 when the CPU 41 as actual hardware reads and executes the electronic receipt managing program P1 and the warranty managing program P16 from the storage unit 43.

The reception unit 61 receives electronic receipt information which is related to merchandise sales data.

The warranty presence determining unit 62 determines whether or not warranty information is stored in the warranty information storage region corresponding to the electronic receipt information which is received by the reception unit 61.

When the warranty presence determining unit 62 determines that the warranty information is not stored, the transmission unit 63 transmits the electronic receipt information which is received by the reception unit 61 to the electronic receipt managing server 9, and when the warranty presence determining unit 62 determines that the warranty information is stored, the warranty information and the electronic receipt information, correlated with each other, are transmitted to the electronic receipt managing server 9.

In addition, in the flowchart in FIG. 9, the CPU 41 (reception unit 61) of the electronic receipt server 6 determines whether or not the electronic receipt information which is transmitted from the POS terminal 2 is received through a network interface 44 (step S41). When it is determined that the information is received (Yes in step S41), the CPU 41 stores the information as electronic receipt information in the electronic receipt managing region 43a of the storage unit 43 (step S42).

Subsequently, the CPU 41 reads the merchandise information included in the received electronic receipt information (step S43). In step S43, the CPU 41 searches whether or not warranty information corresponding to the merchandise information which is included in the received electronic receipt information is stored in the warranty managing region 43a1. When the information is stored, the warranty information is read from the warranty managing region 43a1.

Subsequently, the CPU 41 (warranty presence determining unit 62) determines whether or not the warranty information is present based on the searched result (step S44). When it is determined that the information is present (Yes in step S44), the CPU 41 stores the read warranty information in the electronic receipt managing region 43a of the storage unit 43 in such a manner that the warranty information is correlated with the stored electronic receipt information (step S45). When it is determined that the warranty information is not present (No in step S44), the CPU 41 ends the process.

When the CPU 41 determines that the electronic receipt information is not received (No in step S41), the CPU 41 determines whether or not it is time for transmitting the electronic receipt information which is stored in the electronic receipt managing region 43a, or the warranty information to the electronic receipt managing server 9 (step S51). The CPU 41 determines that it is transmitting time when it is a predetermined time, or at every predetermined time interval. When determining that it is transmitting time (Yes in step S51), the CPU 41(transmission unit 63) transmits the electronic receipt information which is stored in the electronic receipt managing region 43a, or the warranty information to the electronic receipt managing server 9 (step S52).

When determining that it is not time for transmitting the electronic receipt information, or the warranty information to the electronic receipt managing server 9 (No in step S51) in step S51, the CPU 41 determines whether or not there is an inquiry about the warranty information in step S22 from the POS terminal 2 (step S61). The determination of the presence of the inquiry is made depending on whether or not a command of the inquiry and merchandise information on the purchased merchandise are received from the POS terminal 2. When determining that there is the inquiry (Yes in step S61), the CPU 41 searches whether or not the warranty information is stored in the warranty managing region 43a1 (step S62). When the warranty information is stored, the warranty information is read from the warranty managing region 43a1.

Subsequently, the CPU 41 determines whether or not the warranty information is present based on a searched result (step S63). When determining that the warranty information is present (Yes in step S63), the CPU 41 transmits the read warranty information to the POS terminal 2 where the inquiry is made (step S64). When determining that there is no inquiry about the warranty information (No in step S61), and determining that there is no warranty information (No in step S63), the CPU 41 ends the process.

In addition, it is set such that the electronic receipt information is generated by the CPU 21 (electronic receipt generation unit 26) of the POS terminal 2, and is transmitted to the electronic receipt server 6, however, it is not limited to this. For example, the CPU 41 of the electronic receipt server 6 may generate electronic receipt information by adding a company code, codes of a type of business, or the like when the CPU 21 of the POS terminal 2 transmits a store code, a membership code of a consumer, a POS number of the POS terminal 2, a receipt number, merchandise sales data, or the like, to the electronic receipt server 6 based on merchandise information and settlement information which are registered when making settlement using the merchandise sales data processing.

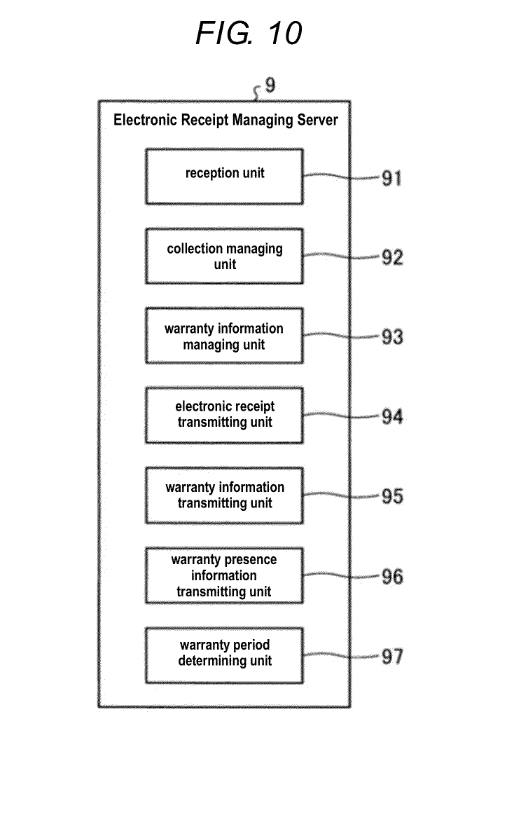

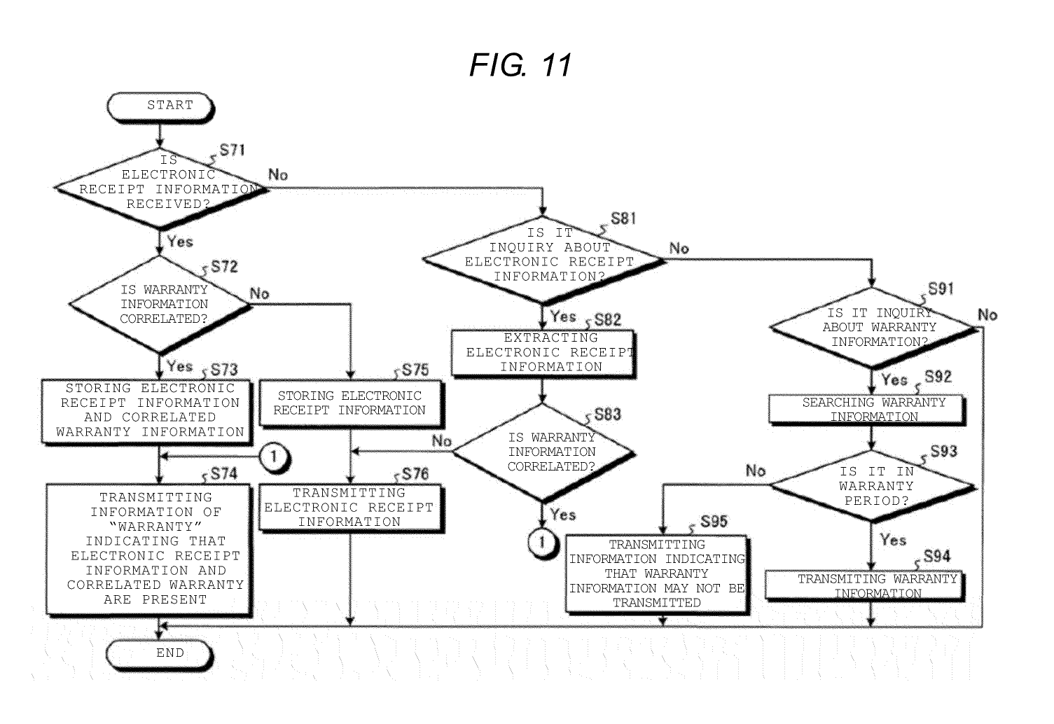

Subsequently, a flow of the electronic receipt managing processing, which is executed when the CPU 51 of the electronic receipt managing server 9 is operated according to the electronic receipt managing program P3, a flow of merchandise information transmission processing, which is executed when the CPU is operated according to the information transmitting program P4, and a flow of warranty managing processing, which is executed when the CPU is operated according to the warranty managing program P17, will be described with reference to a block diagram which is illustrated in FIG. 10, and a flowchart which is illustrated in FIG. 11.

As illustrated in FIG. 10, the electronic receipt managing program P3, the information transmitting program P4, and the warranty managing program P17, which are executed in the electronic receipt managing server 9 have modular configurations, including a reception unit 91 which functions as the reception means, a collection managing unit 92 for electronic receipts which functions as the electronic receipt management means, a warranty information managing unit 93 which functions as the additional information management means, an electronic receipt transmitting unit 94 which functions as the electronic receipt transmission means, a warranty information transmitting unit 95 which functions as the additional information transmission means, a warranty presence information transmitting unit 96 which functions as the additional information presence information transmission means, and a warranty period determining unit 97 which functions as the period determination means. Each of the above-described units is loaded in a memory 52, when the CPU 51 as actual hardware reads and executes the electronic receipt managing program P3, the information transmitting program P4, and the warranty managing program P17 from the storage unit 53, and the reception unit 91, the collection managing unit 92 for electronic receipts, the warranty information managing unit 93, the electronic receipt transmitting unit 94, the warranty information transmitting unit 95, the warranty presence information transmitting unit 96, and the warranty period determining unit 97 are generated in the memory 52.

The reception unit 91 receives electronic receipt information relating to merchandise sales data.

The collection managing unit 92 for electronic receipts manages a company code denoting a company, and pieces of electronic receipt information which are correlated with a plurality of company codes which are received by the reception unit 91.

The warranty information managing unit 93 manages warranty information of a merchandise along with managed electronic receipt information.

The electronic receipt transmitting unit 94 transmits electronic receipt information including at least one or more company codes which are associated with a membership code with respect to the information processing device which is associated with the membership code of a consumer.

When merchandise information of a merchandise of which a warranty is issued is included in the received electronic receipt information, the warranty information transmitting unit 95 may transmit managed warranty information to the information processing device associated with the membership code of a consumer.

The warranty presence information transmitting unit 96 transmits information indicating a presence of a warranty to the information processing device.

The warranty period determining unit 97 determines whether or not a warranty of a merchandise based on warranty information (information on date on which warranty information is transmitted from electronic receipt server 6, and warranty period information) which is managed by the warranty information managing unit 93 is within the warranty period of the merchandise.

As illustrated in FIG. 11, the CPU 51 of the electronic receipt managing server 9 (reception unit 91) determines whether or not the electronic receipt information which is transmitted from the electronic receipt server 6 of each company, and advertising information are received through a network interface 54 (step S71).

When determining that the electronic receipt information and the advertising information are received (Yes in step S71), the CPU 51 of the electronic receipt managing server 9 determines whether or not warranty information is correlated (step S72). The warranty information is correlated in step S45 as processing of the electronic receipt server 6.

When determining that the warranty information is correlated (Yes in step S72), the CPU 51 (collection managing unit 92 for electronic receipts, and warranty information managing unit 93) stores the electronic receipt information in the electronic receipt managing region 53a, and stores the warranty information in the warranty information storage region 53b (step S73). The CPU 51 causes the electronic receipt information which is stored in the electronic receipt managing region 53a and the warranty information which is stored in the warranty information storage region 53b to be correlated with each other. The CPU 51 stores the electronic receipt information, a flag which indicates a presence of the warranty information, and an address of the warranty information storage region 53b in which the warranty information is stored in the electronic receipt managing region 53a, and causes these to be correlated with each other. In addition, the CPU 51 stores the warranty information and the address of the electronic receipt managing region 53a in which the electronic receipt information is stored in the warranty information storage region 53b.

In addition, the CPU 51 (electronic receipt transmission unit 94 and warranty presence information transmission unit 96) transmits the received electronic receipt information, and the information indicating the presence of the warranty information (additional information) to the mobile terminal 8 associated with the membership code, which is received in step S71 at the same time (step S74). The information indicating the presence of the warranty information is an image of an operation key in which character information of a “warranty” is displayed, for example, and image of an operation key in which a mark indicating a presence of the warranty, or the like, is displayed. In addition, the information indicating the presence of the warranty information may be any information that a person who views a display of the mobile terminal 8 may recognize as indicating a presence of a warranty in the merchandise.

In addition, when determining that no warranty information is correlated (No in step S72) in step S72, the CPU 51 (collection managing unit 92 for electronic receipts) stores the received electronic receipt information in the electronic receipt managing region 53a (step S75). In addition, the CPU 51 (electronic receipt transmitting unit 94) transmits the stored electronic receipt information to the mobile terminal 8 which is specified by a membership code which is received at the same time in step S71 (step S76).

In addition, when determining that the CPU 51 does not receive the electronic receipt information and the advertising information (No in step S71) in step S71, the CPU 51 determines whether or not there is an inquiry about the electronic receipt information from the mobile terminal 8 (step S81). When determining that there is the inquiry about the electronic receipt information from the mobile terminal 8 (Yes in step S81), the CPU 51 searches the electronic receipt managing region 53a, and extracts the electronic receipt information from the electronic receipt managing region 53a (step S82).

In addition, the CPU 51 determines whether or not warranty information is correlated with the extracted electronic receipt information (step S83). The determination is made depending on whether a flag indicating a presence of warranty information is correlated with the extracted electronic receipt information, and is stored, or the address of the warranty information storage region 53b in which the warranty information is stored is correlated with the extracted electronic receipt information, and is stored. When the flag indicating the presence of warranty information is correlated with the extracted electronic receipt information, and is stored, or when the address of the warranty information storage region 53b in which the warranty information is stored is correlated with the extracted electronic receipt information, and is stored, it is determined that the warranty information is correlated with the extracted electronic receipt information.

When the CPU 51 determines that the warranty information is correlated with the extracted electronic receipt information (Yes in step S83), the CPU 51 executes processing in step S74. In addition, when the CPU 51 determines that no warranty information is correlated with the extracted electronic receipt information (No in step S83), the CPU 51 executes processing in step S76.

In addition, when determining that there is no inquiry about the electronic receipt information from the mobile terminal 8 (No in step S81), the CPU 51 determines whether or not there is an inquiry about the warranty information from the mobile terminal 8 (step S91). When the CPU 51 determines that there is no inquiry about the warranty information from the mobile terminal 8 (No in step S91), the CPU 51 ends the process. When the CPU 51 determines that there is the inquiry about the warranty information from the mobile terminal 8 (Yes in step S91), the CPU 51 (warranty period determining unit 97) searches the warranty information storage region 53b (step S92), and determines whether or not the warranty period has expired (step S93).

Whether or not the warranty period has expired is determined based on the date on which the warranty information is transmitted from the electronic receipt server 6, and the warranty period which is stored in the warranty information storage region 53b. That is, when the date of inquiry on the warranty information has not passed the warranty period, the CPU 51 determines that the merchandise which is designated by the warranty information is within the warranty period. In addition, when the date of inquiry on the warranty information has passed the warranty period, the CPU 51 determines that the warranty period of the merchandise which is designated by the warranty information is expired. That is, the CPU determines whether or not the warranty information (additional information) is within a valid period.

When the CPU 51 determines that the inquired warranty information is within the warranty period of the warranty information (Yes in step S93), the CPU 51 (warranty information transmitting unit 95) transmits the extracted warranty information to the mobile terminal 8 in which the inquiry is made (step S94). In addition, when the CPU 51 determines that the inquired warranty information is outside the warranty period of the warranty information (No in step S93), the CPU 51 transmits a message indicating that the warranty information may not be transmitted due to the expired warranty period, to the mobile terminal 8 in which the inquiry is made (step S95).

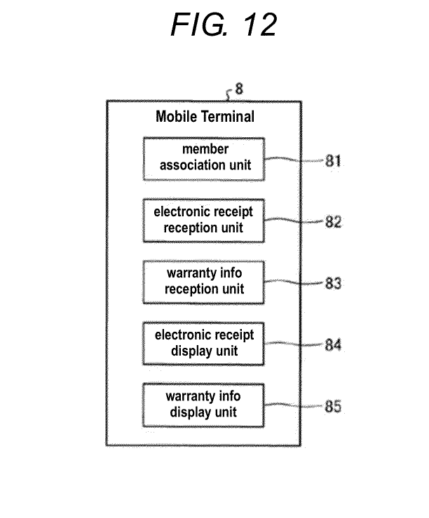

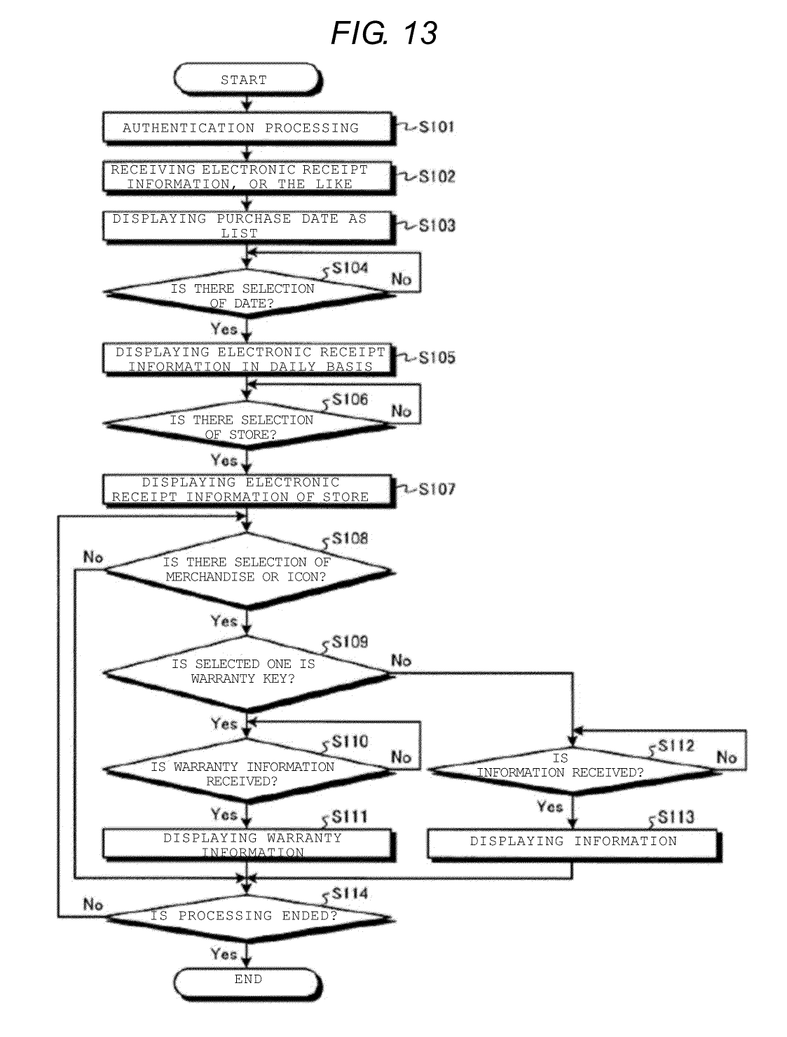

Subsequently, a flow of electronic receipt reception processing which is executed by a CPU 11 of the mobile terminal 8 according to an electronic receipt correspondence program P11, and a flow of electronic receipt read processing which is executed by the CPU according to an electronic receipt read program P12 will be described with reference to a functional block diagram which is illustrated in FIG. 12, and a flowchart which is illustrated in FIG. 13.

As illustrated in FIG. 12, the electronic receipt correspondence program P11 and the electronic receipt read program P12 which are executed in the mobile terminal 8 have modular configurations which include a member association unit which functions as the member association means, an electronic receipt reception unit 82 which functions as the electronic receipt reception means, a warranty information reception unit 83 which functions as the additional information reception means, an electronic receipt display unit 84 which functions as the electronic receipt display means, and a warranty information display unit 85 which functions as the additional information display means. When the CPU 11 as actual hardware reads the electronic receipt correspondence program P11 and the electronic receipt read program P12 from the storage unit 13, and executes the programs, each of the above-described units is loaded in the memory 12, and the member association unit 81, the electronic receipt reception unit 82, the warranty information reception unit 83, the electronic receipt display unit 84, and the warranty information display unit 85 are generated in the memory 12.

The member association unit 81 causes membership codes of a predetermined consumer to be associated with each other.

The electronic receipt reception unit 82 receives electronic receipt information which is associated with the membership code, and includes at least one or more company codes from the electronic receipt managing server 9 which manages the electronic receipt information in a collective manner.

The warranty information reception unit 83 receives warranty information which is correlated with electronic receipt information.

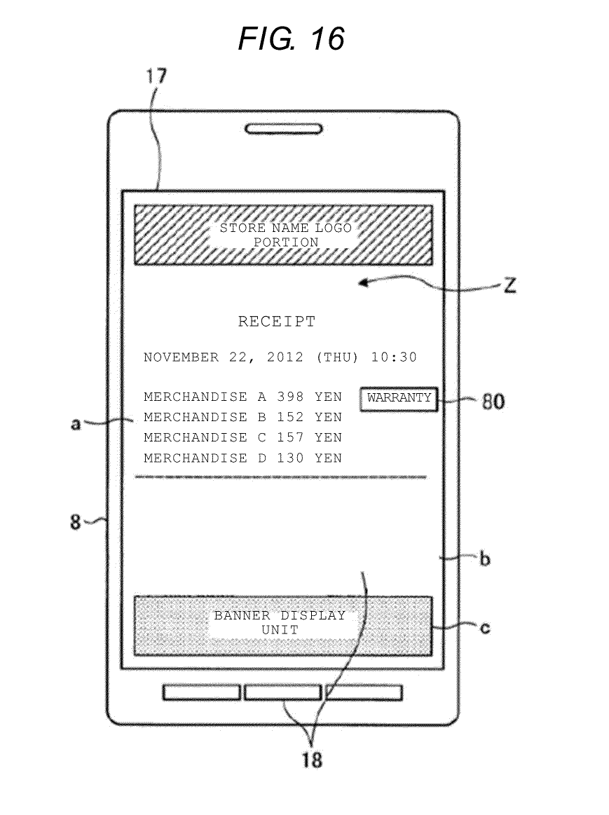

The electronic receipt display unit 84 displays the electronic receipt information which is received by the electronic receipt reception unit 82 on the display unit 17 by aligning the information according to a company code. When receiving information indicating a presence of the warranty information, an image of a warranty key 80 (refer to FIG. 16) is displayed.

When receiving the warranty information by the warranty information reception unit 83, the warranty information display unit 85 displays the warranty information along with the electronic receipt information.

As illustrated in FIG. 13, first, the CPU 11 (member association unit 81) of the mobile terminal 8 executes authentication processing using an input of a membership code and a password by accessing the electronic receipt managing server 9 (step S101). In this manner, the mobile terminal 8 and a membership code of a predetermined consumer are associated with each other.

After the authentication, the CPU 11 (electronic receipt reception unit 82) of the mobile terminal 8 receives the advertising information and electronic receipt information which are managed in the electronic receipt managing region 53a corresponding to the input membership code (step S102). In addition, receiving of the advertising information and electronic receipt information may be performed using email. In addition, the CPU 11 receives information indicating a presence of the warranty.

Subsequently, the CPU 11 (electronic receipt display unit 84) of the mobile terminal 8 displays a date of purchase included in the electronic receipt information on the display unit 17 as a list (step S103). The mobile terminal 8 prompts selecting of information by displaying the list of the dates of purchase on the display unit 17 in this manner.

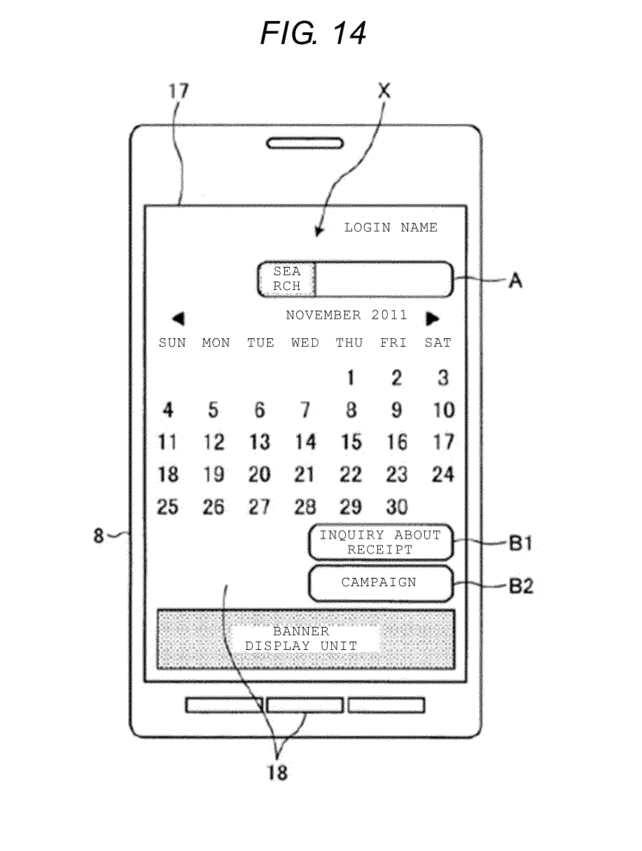

FIG. 14 is a front view which illustrates a display example X on the display unit 17 of the mobile terminal 8. As illustrated in FIG. 14, the display example X is an example in which the dates on which a user having the mobile terminal 8 which accesses the electronic receipt managing server 9 has shopped, are displayed as a list in a form of a calendar by changing a color thereof. In addition, the CPU 11 (electronic receipt display unit 84) of the mobile terminal 8 performs a display so that a desired date may be selected using a cursor which follows an input of the input unit 18 among dates which are displayed as a list by changing the color thereof.

In addition, as illustrated in FIG. 14, a search window A for entering a search term or a keyword, is provided in the display example X. The CPU 11 of the mobile terminal 8 may narrow down the electronic receipt information based on the search term or the keyword entered in the search window A.

In addition, as illustrated in FIG. 14, the display example X includes a “receipt inquiry” button B1 for confirming a desired date after selecting the date using a cursor. The CPU 11 of the mobile terminal 8 may determine that a user selects a desired date only by the date being tapped, and may determine that the date is selected when the user operates the “receipt inquiry” button B1 after tapping the desired date.

The CPU 11 (electronic receipt display unit 84) of the mobile terminal 8 determines whether or not the user selects the desired date by tapping the date (step S104). The CPU 11 stands by until the date is selected (No in step S104), and when determining that the date is selected (Yes in step S104), the CPU 11 displays electronic receipt information corresponding to the selected date on the display unit 17 (step S105). The CPU 11 displays image information of the warranty key 80 which is information indicating the presence of the warranty by making the information be located on the right side of a merchandise price of the corresponding merchandise.

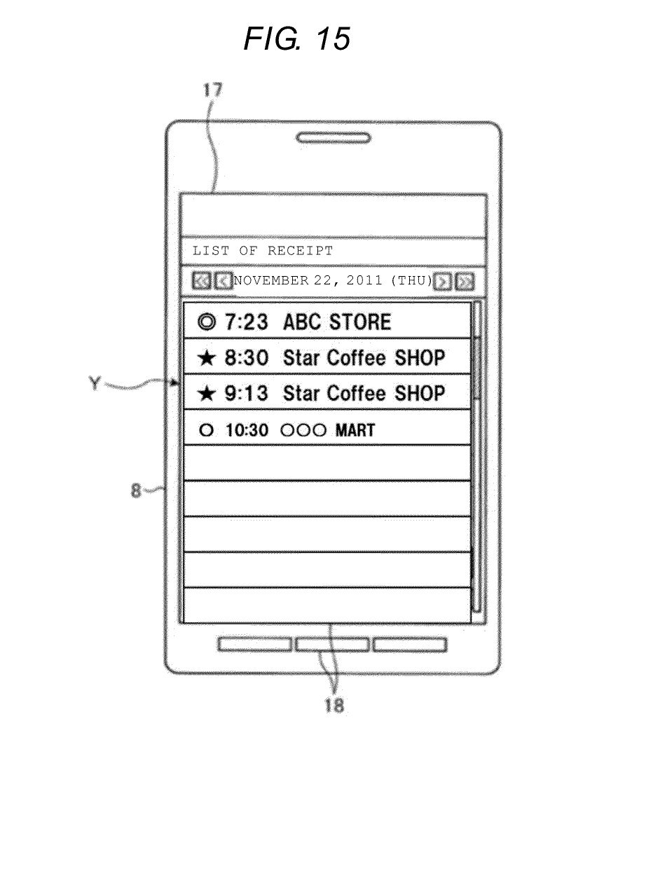

FIG. 15 is a front view which illustrates a display example Y in a mobile terminal. As illustrated in FIG. 15, the display example Y is an example in which various stores of companies at which a user having the mobile terminal 8 which accesses the electronic receipt managing server 9 has shopped, are displayed by date as a list. More specifically, the display example Y is an example in which the electronic receipt information is displayed in time sequence in order of being received, and in which a mark of a company, business hours, a name of company, and a name of store are displayed. In addition, the CPU 11 (electronic receipt display unit 84) of the mobile terminal 8 performs a display so that a store on a desired date may be selected using a cursor which follows an input of the input unit 18 among the pieces of store information which are displayed as a list by date.

The CPU 11 (electronic receipt display unit 84) of the mobile terminal 8 determines whether or not the user selects a store on a desired date (step S106). The CPU stands by until the store is selected (No in step S106), and when determining that the store on the desired date is selected (Yes in step S106), the CPU 11 displays electronic receipt information corresponding to the store on a date which is selected on the display unit 17 (step S107). The CPU 11 displays image information of the warranty key 80 which is information indicating the presence of the warranty by making the information be located on the right side of a merchandise price of the corresponding merchandise.

FIG. 16 is a front view which illustrates a display example Z on the display unit 17 of the mobile terminal 8. As illustrated in FIG. 16, the display example Z is an example in which electronic receipt information on a desired store on a desired date on which a user having the mobile terminal 8 which accesses the electronic receipt managing server 9 has shopped, is displayed. In the display example Z, it is possible to make the same layout as a paper receipt by analyzing the electronic receipt information, and to focus on a merchandise A using a cursor which follows an input of the input unit 18 among listed merchandises.

In addition, a display image of a screen is not necessarily a receipt image. However, the electronic receipt information substitutes paper receipt information, and is electronic certification information of a merchandise purchase which certifies a purchase of a merchandise. In the display example Z, the following information is displayed so as to be used when being presented as the certification information of merchandise purchase to a store in a case of returning a merchandise.
store name
purchase date
description of purchased merchandise
total sales amount
received money
change
cash register number
transaction number
warranty key

As illustrated in FIG. 16, when receiving information indicating that a warranty is present among merchandises which are displayed in the description of purchased merchandises, the warranty key 80 as a type of an icon is displayed on the display unit 17 corresponding to correlated merchandise information. The warranty key 80 is displayed at a position on the right side of a merchandise price. The warranty key 80 is image information of an operation key. The warranty key is displayed along with characters of “warranty”, for example. In FIG. 16, a presence of a warranty is indicated in the “merchandise A”. The presence of a warranty is not indicated in the “merchandise B”, “merchandise C”, and the “merchandise D”. The displayed warranty key 80 may be operated when a person touches the display screen. When the warranty key 80 is operated, inquiry information about warranty information relating to the merchandise information is transmitted to the electronic receipt managing server 9.

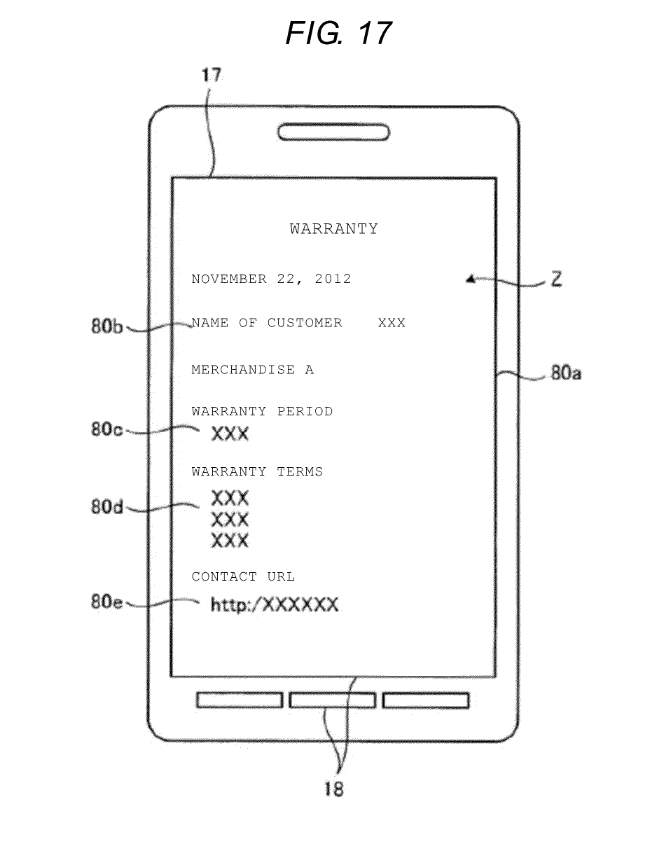

FIG. 17 illustrates an example of warranty information 80a which is displayed on the display unit 17 when the warranty key 80 is operated, and the warranty information is received from the electronic receipt managing server 9, when an inquiry of the warranty information is made from the mobile terminal 8. In the warranty information 80a, customer information, merchandise information 80b of a purchased merchandise, a warranty period 80c, warranty regulation 80d setting warranty conditions or a provision of deciding a contract, a contact address (email address, or the like) 80e of a manufacturer who issues a warranty, and the like, are displayed, in addition to a display indicating that displayed information is the warranty. The contact address is displayed so as to be operated, and it is possible to access a homepage of the manufacturer by being operated. In addition, the displayed warranty information may be stored by being downloaded to the mobile terminal 8.

Here, the CPU 11 determines whether or not a user selects an appropriate merchandise, or an icon which is associated with the merchandise (step S108). When determining that the merchandise or the icon is selected (Yes in step S108), the CPU 11 determines whether or not the selected icon is the warranty key 80 (step S109). When determining that it is the warranty key 80 (Yes in step S109), the CPU 11 (warranty information reception unit 83) determines whether or not warranty information is received from the electronic receipt managing server 9 (step S110). The CPU 11 stands by until the information is received (No in step S110), and when it is determined that the information is received (Yes in step S110), the CPU 11 (warranty information display unit 85) displays the received warranty information on the display unit 17 of the mobile terminal 8 (step S111). Details of the warranty information which is displayed on the display unit 17 will be described later with reference to FIG. 17. In addition, when a warranty period of the inquired warranty information is expired, the CPU 11 displays a message indicating that the warranty period is expired.

In addition, when determining that the selected one is not the warranty key 80 (No in step S109), the CPU 11 determines whether or not information relating to the selected icon is received (step S112). The CPU 11 stands by until the information is received (No in step S112), and when determining that the information is received (Yes in step S112), the CPU displays the received information on the display unit 17 of the mobile terminal 8 (step S113).

For example, when a homepage which is correlated with a merchandise is set as a merchandise information link, as access information with respect to a merchandise a, a homepage which is correlated with a desired merchandise is displayed on the display unit 17 in a case in which the merchandise is selected.

In addition, when a homepage which is correlated with a commercial is set as access information with respect to a banner c as a type of an icon, a commercial which is correlated with the banner c is displayed on the display unit 17 in a case in which the banner c is selected.

When determining that there is no selection of a merchandise or an icon after displaying warranty information or other information on the display unit 17, in step S108 (No in step S108), the CPU 11 determines whether or not processing in the mobile terminal 8 is ended (step S114). When determining that the processing is ended (Yes in step S114), the CPU 11 ends the processing. When determining that the processing is not ended (No in step S114), the CPU 11 returns to the processing in step S108.

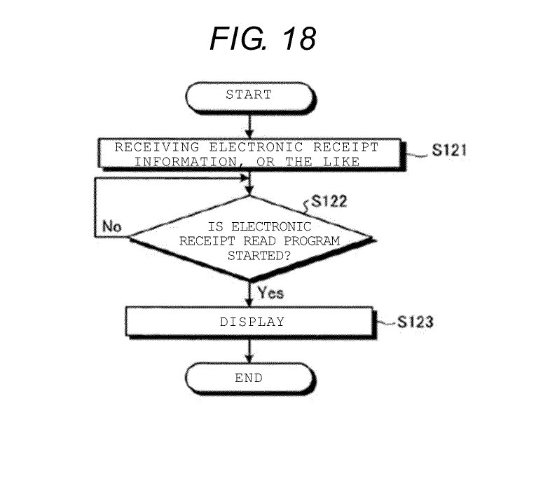

In addition, as described in step S102 in FIG. 13, (which is described above), descriptions will be made with reference to a flowchart in FIG. 18 as well in a case in which the mobile terminal 8 receives electronic receipt information and advertising information from the electronic receipt managing server 9, without accessing the electronic receipt managing server 9 from the mobile terminal 8.

The CPU 11 (electronic receipt reception unit 82) of the mobile terminal 8 receives the electronic receipt information and advertising information from the electronic receipt managing server 9 (step S121).

Thereafter, the CPU 11 of the mobile terminal 8 determines whether or not the electronic receipt read program P12 is started (step S122). The CPU 11 stands by until the program is started (No in step S122), and when determining that the program is started (Yes in step S122), the CPU 11 (electronic receipt display unit 84) of the mobile terminal 8 displays the received electronic receipt information and advertising information by causing the information to be correlated with a company code (step S123).

In this manner, according to the embodiment, since it is possible to introduce a mechanism of an electronic receipt by deviating from the standard pattern of a company, differently from a mechanism of an electronic receipt in a company unit in the related art, introducing of the electronic receipt may be promoted in this manner.

In addition, according to the embodiment, since warranty information is managed by being correlated with electronic receipt information, it is possible to display the warranty information on the mobile terminal 8 by transmitting the information to the mobile terminal.

In addition, according to the embodiment, it is possible to display warranty information on the mobile terminal 8 by displaying a presence of the warranty information on the mobile terminal 8, and by operating the mobile terminal 8.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, when a merchandise of which a warranty is present is purchased, information indicating the presence of the warranty may not be transmitted to the mobile terminal 8, and the warranty information may be transmitted to the mobile terminal 8 along with electronic receipt information without notice. In this case, the received electronic receipt information and the warranty information are displayed on the mobile terminal 8 at the same time.

In addition, the warranty information may be stored in the electronic receipt managing server 9, not in the electronic receipt server 6.

In addition, warranty information of which a warranty period is expired may be transmitted to the mobile terminal 8 along with information indicating expiration of the warranty period, and the mobile terminal 8 may display the warranty information along with a message indicating that the warranty period is expired.

What is claimed is:

1. An electronic receipt managing server comprising:
a reception unit configured to receive electronic receipt information relating to a sale of a merchandise at a store to a consumer;
an electronic receipt management unit configured to manage the electronic receipt information;
an additional information management unit configured to manage additional information of the merchandise with the electronic receipt information;
an electronic receipt transmission unit configured to transmit the electronic receipt information to an information processing device associated with a code of the consumer; and
an additional information transmission unit configured to transmit the additional information to the information processing device.

2. The server according to claim 1, further comprising:
an additional information presence information transmission unit configured to transmit information indicating a presence of the additional information to the information processing device.

3. The server according to claim 2, wherein the additional information transmission unit is configured to transmit the additional information to the information processing device upon receiving an inquiry for the additional information from the information processing device.

4. The server according to claim 3, further comprising:
a period determination unit configured to determine whether or not the inquiry for the additional information is made within a period in which the additional information is valid,
wherein the additional information transmission unit is configured to transmit the additional information to the information processing device when the inquiry is made within the period and to not transmit the additional information when the inquiry is made after the period.

5. The system according to claim 4, wherein the additional information is warranty information and the period in which the additional information is valid is a warranty period.

6. The server according to claim 5, wherein the additional information transmission unit is configured to transmit information indicating that the warranty period for the merchandise has expired.

7. The server according to claim 5, wherein the warranty information includes merchandise name, warranty period, and warranty terms.

8. An information processing device comprising:
an electronic receipt reception unit configured to receive electronic receipt information from an electronic receipt managing server that manages the electronic receipt information;
an additional information reception unit configured to receive additional information relating to the electronic receipt information;
an electronic receipt display unit configured to display the electronic receipt information; and
an additional information display unit configured to display information relating to the additional information.

9. The device according to claim 8, wherein
the additional information reception unit is configured to receive information indicating a presence of the additional information, and
the additional information display unit is configured to display the information indicating the presence of the additional information as the information relating to the additional information.

10. The device according to claim 9, wherein the information indicating the presence of the additional information is a selectable element, which when operated on, causes the additional information to be displayed.

11. The device according to claim 9, wherein the information relating to the additional information is a message indicating that the additional information is not transmitted.

12. The system according to claim 8, wherein the additional information is warranty information and the period in which the additional information is valid is a warranty period.

13. The device according to claim 8, wherein the electronic receipt display unit is configured to display a list of merchandises included in the electronic receipt information and a selectable element for each of the merchandises that have valid warranty information.

14. The device according to claim 13, wherein the additional information display unit is configured to cause the warranty information to be displayed in response to a user operation on the selectable element.

15. The device according to claim 14, wherein the warranty information includes merchandise name, warranty period, and warranty terms.

16. An information processing method comprising:
receiving electronic receipt information that includes merchandise sales data on one or more merchandises sold, from an electronic receipt managing server that manages the electronic receipt information;
receiving information relating to a warranty for each of the merchandises sold; and
displaying the electronic receipt information as a list of names of merchandises sold, one or more of which is displayed alongside an indication that a warranty is in effect therefor.

17. The method according to claim 16, wherein the information relating to a warranty is warranty information if a warranty is in effect and a message indicating that the warranty information is not transmitted if a warranty is not in effect.

18. The method according to claim 17, wherein the merchandises sold includes a first merchandise for which a warranty is in effect and a second merchandise for which a warranty is not in effect, and a user selectable button is displayed alongside the name of the first merchandise and not displayed alongside the name of the second merchandise.

19. The method according to claim 16, wherein the indication is a user selectable button, which when selected causes a display of the warranty information for the corresponding merchandise.

20. The device according to claim 19, wherein the warranty information includes the merchandise name, warranty period, and warranty terms.
